(19) United States
(12) Patent Application Publication
(10) Pub. No.: US 2009/0265086 A1
(43) Pub. Date: Oct. 22, 2009

(54) Diagnosis Apparatus for Internal Combustion Engine

(75) Inventors: Yoichi IIHOSHI, Tsuchiura (JP); Yoshikuni Kurashima, Mito (JP); Toshio Hori, Hitachinake (JP); Shin Yamauchi, Mito (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 12/425,033

(22) Filed: Apr. 16, 2009

(30) Foreign Application Priority Data
Apr. 17, 2008 (JP) 2008-107388

(51) Int. Cl. F02D 41/06; F02M 7/00

(52) U.S. Cl. 701/113; 123/435

(57) ABSTRACT

A diagnosis apparatus for an internal combustion engine equipped with a cold start emission reduction strategy unit, includes: a temperature measuring unit for detecting a temperature of coolant of the internal combustion engine; a temperature estimating unit for calculating an estimated temperature of the coolant in accordance with a running state of the internal combustion engine; and a cold start emission reduction strategy abnormality judging unit for judging abnormality of the cold start emission reduction strategy unit in accordance with the temperature detected with the coolant temperature measuring means and the estimated temperature.

### BACKGROUND OF THE INVENTION

The present invention relates to a diagnosis apparatus for an internal combustion engine for self-diagnosing abnormality of the internal combustion engine, and more particularly to a diagnosis apparatus for detecting abnormality of cold start emission reduction strategy to reduce emission at the start time.

The term “cold start emission reduction strategy” is used in the regulation of On Board Diagnosis (OBD) II, and is a generic designation for various methods of reducing exhaust emission immediately after the start of an engine. Examples of cold start emission reduction strategy are retarding of an ignition timing, fast idle to increase idle speed, twice fuel injections per one cycle, and the like. Representative examples of the cold stat emission strategy are retarding of the ignition timing and the first idle operation. The cold start emission reduction strategy operation promotes the rise of exhaust temperature so that a catalyst disposed in the exhaust system is activated earlier. As catalyst becomes active, a purification efficiency of exhaust emission by catalyst becomes very high. However, an exhaust emission purification performance of a vehicle degrades considerably if cold start emission reduction strategy does not operate normally. For this reason, the diagnosis regulation demands also for a method of detecting abnormality of cold start emission reduction strategy.

A simple method of detecting abnormality of cold start emission reduction strategy is to detect abnormality by setting a threshold value to each of parameters such as the ignition timing and an engine speed. It is however difficult to readily determine the threshold values because the ignition timing and engine speed always vary with a vehicle running state. Techniques may be considered which estimate the state of catalyst not from each parameter but from a running state of an internal combustion engine. For example, disclosed well-known techniques include techniques (JP-A-2003-201906) of estimating a catalyst temperature from the running state, and techniques (JP-A-2007-177631) of estimating exhaust emission downstream of catalyst. These techniques judge abnormality from a catalyst temperature or an accumulated value of exhaust emission downstream of catalyst, during or after execution of cold state emission reduction strategy.

### SUMMARY OF THE INVENTION

An object of the present invention is to provide a method capable of detecting abnormality of cold start emission reduction strategy even if the characteristics of an internal combustion engine change with aging.

The present invention provides a diagnosis apparatus for abnormality of cold start emission reduction strategy, paying attention to an increase in wall heat losses (cooling losses) caused by an increase in gas losses (exhaust emission heat amount). Namely, the invention provide a diagnosis apparatus for an internal combustion engine, comprising: a coolant temperature measuring unit for detecting a temperature of coolant of the internal combustion engine; a temperature estimating unit for calculating an estimated temperature of the coolant in accordance with a running state of the internal combustion engine; and a cold start emission reduction strategy abnormality judging unit for judging abnormality of a cold start emission reduction strategy unit in accordance with the temperature detected with the coolant temperature measuring unit and the estimated temperature.

According to the present invention, a method can be provided which can detect abnormality of cold start emission reduction strategy even if the characteristics of an internal combustion engine change with aging.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating the whole structure of a cylinder injection type internal combustion engine.

FIG. 2 illustrates an example of a timing chart of cold start emission reduction strategy.

FIG. 3 illustrates an example of a diagnosis system.

FIG. 4 illustrates an example of a timing chart of the diagnosis system.

FIG. 5 illustrates heat efficiencies in a normal state and an abnormal state.

FIG. 6 illustrates another example of a diagnosis system.

FIG. 7 illustrates a relation between retarding of an ignition timing and a wall heat loss.

FIG. 8 is a diagnosis block diagram illustrating the summary of an embodiment.

FIG. 9 illustrates an example of a timing chart of the embodiment.

FIG. 10 illustrates an example of abnormality judgment.

FIG. 11 illustrates an example of a flow chart of the embodiment.

FIG. 12 illustrates a method of calculating an estimated coolant temperature.

FIG. 13 illustrates a calculation block diagram for a wall heat loss.

FIGS. 14A and 14B illustrate examples of a wall heat loss map and a table.

FIG. 15 illustrates a calculation block diagram for a heat radiation amount.

FIG. 16 illustrates an example of a heat radiation coefficient (EH) table.

FIG. 17 illustrates a calculation block diagram for radiated heat mount when fuel is cut.

FIG. 18 illustrates an example of a heat radiation coefficient (EC) table.

FIG. 19 illustrates a calculation block diagram for a cooling coolant temperature.

FIG. 20 illustrates an example of a heat exchange coefficient (KC) table.

FIG. 21 illustrates an example of setting a diagnosis threshold value based on a coolant temperature at the start time.

FIG. 22 is a timing chart according to another embodiment of the present invention.

FIG. 23 illustrates an example of setting a diagnosis threshold value based on a difference between a plurality of estimated coolant temperatures.

FIG. 24 is a timing chart illustrating a coolant temperature during abnormality of a thermostat.

FIG. 25 illustrates an example of an abnormality judging method separately judging for a thermostat and cold start emission reduction strategy.

FIG. 26 illustrates an example of another abnormality judging method separately for a thermostat.

### DESCRIPTION OF THE EMBODIMENTS

According to an embodiment of the present invention, the diagnosis apparatus for an internal combustion engine equipped with a cold start emission reduction strategy unit includes: a coolant temperature measuring unit for detecting a temperature of coolant for the internal combustion engine; a coolant temperature estimating unit for calculating an estimated the coolant temperature in accordance with a running state of the internal combustion engine; cold start emission reduction strategy abnormality judging unit for judging abnormality of the cold start emission reduction strategy unit in accordance with the measured coolant temperature and the estimated coolant temperature. According to the embodiment, an increase in a wall heat loss when the cold start emission reduction strategy is executed is detected with a coolant temperature sensor, and the measured coolant temperature is compared with the estimated coolant temperature so that abnormality of the cold start emission reduction strategy can be detected correctly.

According to another embodiment, at least one of an amount of ignition timing retarding, an increased amount of intake air and an increased amount of the idle speed by the cold state emission reduction strategy unit is used as the running state of the internal combustion engine. According to the embodiment, since an increase in a wall heat loss by the cold start emission reduction strategy can be calculated more precisely, a diagnosis precision can be improved.

According to another embodiment, the coolant temperature estimating unit obtains a heat exchange amount which is a portion of cooling heat calculated from the running state of the internal combustion engine in accordance with a difference between a temperature of a cylinder block of the internal combustion engine and a coolant temperature, and estimates a coolant temperature from the heat exchange amount. According to the embodiment, even if a vehicle runs under execution or termination of the cold start emission reduction strategy, a coolant temperature can be estimated precisely so that diagnosis under broader conditions is possible.

According to another embodiment, the cold start emission reduction strategy unit is judged abnormal if a difference between the measured coolant temperature and the estimated coolant temperature is larger than a first predetermined value determined from a coolant temperature at the start time. According to the embodiment, diagnosis can be made reliably even if the coolant temperature does not rise too much because of the coolant temperature at the start time is high.

According to another embodiment, an estimated temperature A of the coolant when the cold start emission reduction strategy unit is not used is calculated, an estimated temperature B of the coolant when the cold start emission reduction strategy unit is used is calculated, and abnormality of the cold start emission reduction strategy unit is judged in accordance with at least two of the estimated temperature A, the estimated temperature B, and the measured coolant temperature. According to the embodiment, abnormality judgment can be made more reliably because an influence of the cold start emission reduction strategy upon a coolant temperature can be calculated precisely.

According to another embodiment, the cold start emission reduction strategy unit is judged abnormal if a difference between the estimated temperature A and the estimated temperature B when control by the cold state emission reduction strategy unit is completed is smaller than a second predetermined value determined from a coolant temperature at the start time. According to the embodiment, abnormality that the cold stare emission reduction strategy is executed hardly can be detected reliably.

According to another embodiment, abnormality of the cold start emission reduction strategy unit is judged through comparison between at least one of a difference between the estimated temperature A and the measured temperature, a difference between the estimated temperature B and the measured temperature, and a third predetermined value determined from a difference between the estimated temperature A and the estimated temperature B. According to the embodiment, a judgment threshold value corresponding to the influence degree of the cold start emission reduction strategy can be set so that abnormality judgment can be realized more reliably.

According to another embodiment, abnormality of the cold state emission reduction strategy unit and a thermostat for switching between flow paths of the coolant in accordance with a temperature is judged separately in accordance with a first judgment value based on the estimated coolant temperature and the measured coolant temperature when control by the cold start emission reduction strategy unit is completed and a second judgment value based on the estimated coolant temperature and the measured coolant temperature near at a temperature of switching between the flow paths by the thermostat.

Alternatively, a thermostat for switching between flow paths of the coolant in accordance with a temperature is judged abnormal if the measured temperature is lower than the estimated temperature B when control by the cold start emission reduction strategy unit is completed. According to the embodiment, abnormality of the cold start emission reduction strategy and the thermostat can be judged separately.

According to the embodiments described above, even if an exhaust emission temperature lowers due to a change in the characteristics of an internal combustion engine by aging, abnormality can be detected.

Embodiments of the present invention will be described with reference to the accompanying drawings.

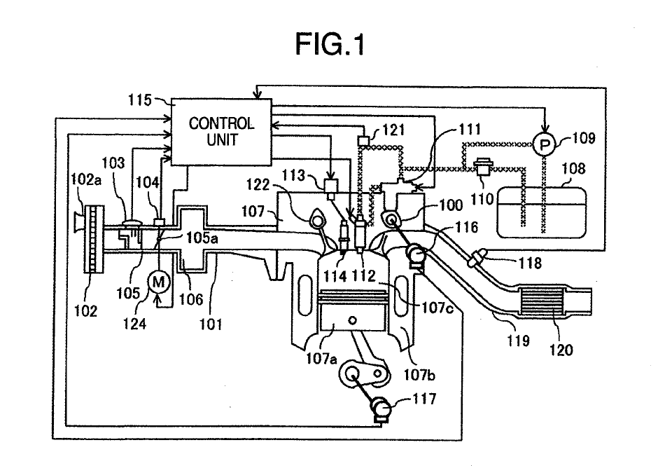

FIG. 1 illustrates an example of the whole structure of a cylinder injection type internal combustion engine applying the present invention. Intake air introduced into a cylinder 107b is supplied via an input port 102a of an air cleaner 102, passes through an air flow sensor 103 which is one of running state measuring apparatus of the internal combustion engine, and enters a collector 106 via a throttle body 105 accommodating an electrical control throttle valve 105a for controlling an intake air flow. A signal representative of an intake air flow is output from the air flow sensor 103 to a control unit 115 serving as an internal combustion engine controller. A throttle sensor 104 for detecting an opening degree of the electrical control throttle valve 105a, which is one of running state measuring apparatus of the internal combustion engine controller, is mounted in the throttle body 105, and outputs a signal to the control unit 115. Upon reception of a signal from the throttle sensor 104, the control unit makes a motor 124 rotate, to control the electrical control throttle valve 105a. Air sucked in the collector 106 is distributed to intake tubes 101 connected to a plurality of cylinders 107b equipped in the internal combustion engine 107, and thereafter introduced into a combustion chamber 107c of the cylinder 107b. The combustion chamber 107c is constituted of the cylinder 107b and a piston 107a.

Fuel such as gasoline in a fuel tank 108 is firstly pressurized by a fuel pump 109, regulated to a constant pressure by a fuel pressure regulator 110, and secondarily pressurized to a high pressure by a high pressure fuel pump 111 to be pressure-transported to a fuel rail. The high pressure fuel from the high pressure fuel pump 111 is injected from an injector 112 mounted on the cylinder 107b into the combustion chamber 107c. A pressure of fuel supplied to the injector 112 is detected with a fuel pressure sensor 121. Fuel injected into the combustion chamber 107c is burned by an ignition signal of high voltage made by an ignition coil 113 and output from an ignition plug 114. A cam angle sensor 116 mounted on a cam shaft of an exhaust valve outputs a signal for detecting a phase of the cam shaft to the control unit 115. The cam angle sensor 116 may be mounted on a cam shaft on the intake valve side. Reference numeral 122 represents a cam on the intake valve side, and reference numeral 100 represents a cam on the exhaust valve side. In order to detect the rotation and phase of a crank shaft of the internal combustion engine, a crank angle sensor 117 is mounted on a crank shaft, and an output from the crank angle sensor is input to the control unit 115. An air/fuel ratio sensor 118 mounted in an exhaust pipe 119 upstream of catalyst 120 detects oxygen in exhaust gas, and outputs its detection signal to the control unit 115. The embodiment is not limited to a cylinder injection internal combustion engine such as shown in FIG. 1, but a port injection internal combustion engine may also be used.

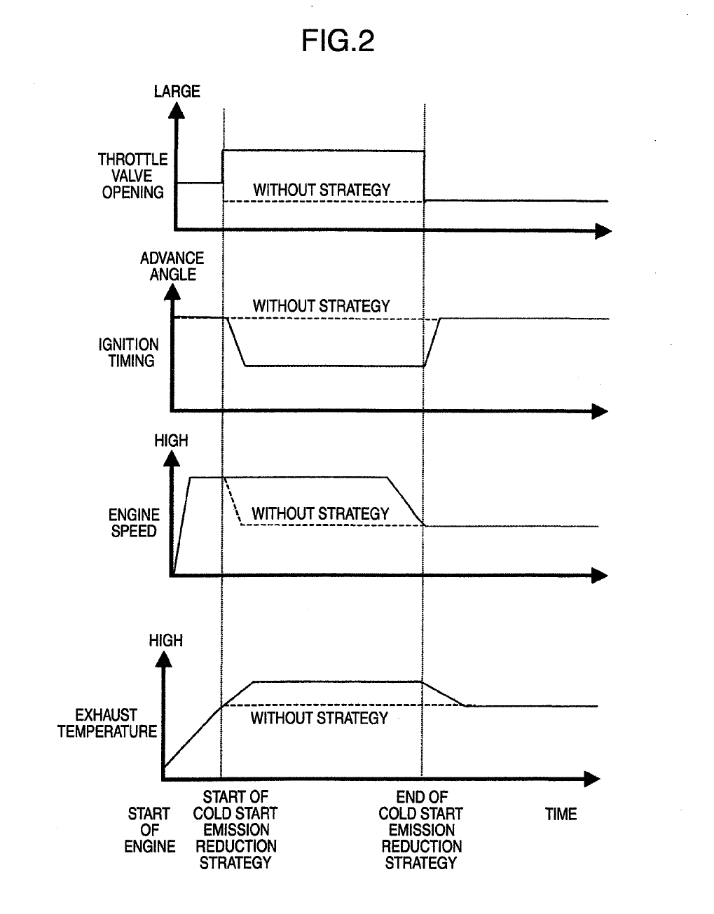

FIG. 2 illustrates an example of a timing chart of cold start emission reduction strategy. For example, if a coolant temperature of the internal combustion engine is lower than a predetermined temperature after the start of the internal combustion engine, it is judged that catalyst is not activated, and the cold start emission reduction strategy starts. During this strategy, in order to activate the catalyst faster than a hot start (no cold start emission reduction strategy) in the warmed-up engine, the throttle is opened, an ignition timing is retarded, and an engine speed is increased. As compared to the case in which the strategy is not executed, an exhaust emission temperature rises by about 200 to 300° C. and an intake air amount is nearly doubled, during this strategy. When it is judged, for example, from a strategy execution time, an accumulated intake air amount or the like, that the catalyst becomes active, the cold start emission reduction strategy is terminated.

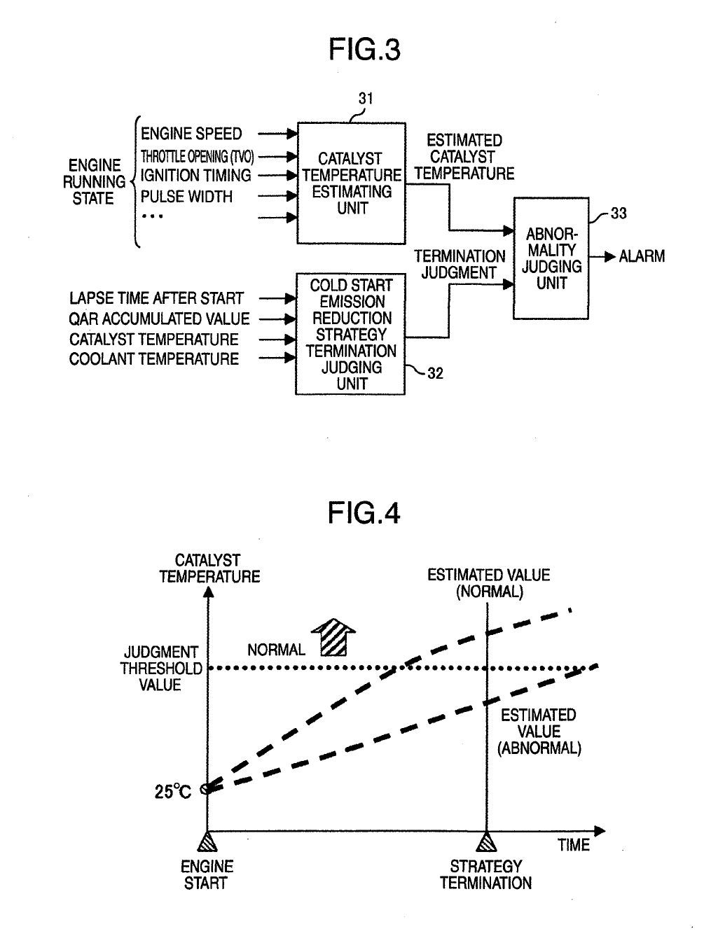

FIG. 3 illustrates an example of a diagnosis system block diagram. According to this diagnosis technique, there are provided a catalyst temperature estimating unit 31 for estimating a catalyst temperature from an internal combustion engine running state such as an engine speed and a termination judging unit 32 for judging termination of the cold start emission reduction strategy, and abnormality of the cold start emission reduction strategy is judged by an abnormality judging unit 33 in accordance with an estimated catalyst temperature at the time of termination judgment.

FIG. 4 illustrates an example of a timing chart of the diagnosis system. According to this diagnosis technique, a judgment threshold value to be reached before termination of the strategy is determined in advance. If a catalyst temperature estimated by the catalyst temperature estimating unit 32 illustrated in FIG. 3 exceeds this judgment threshold value before termination of the strategy, it is judged normal. If the estimated value does not exceed the threshold value, it is judged abnormal. In this manner, abnormality can be detected more easily than setting each threshold value to each parameter such as the engine speed and the ignition timing.

FIG. 5 illustrates heat balance in a normal state and in an abnormal state. Fuel injected into an internal combustion engine is changed to heat excepting unburned fuel such as adherent fuel, providing an internal combustion engine indicated work (engine output), a gas loss (exhaust gas) and a wall heat loss (cooling). According to the aforementioned example of the diagnosis system, although a first abnormality of reducing total heating value can be detected, a second abnormality of reducing after-burning and increasing unburned fuel cannot be detected. Because the second abnormality has the same total output as that of the normal state under execution of the cold start emission reduction strategy, and the internal combustion engine running state such as an engine speed and an intake air amount does not change. Unburned fuel before catalyst activation is a important factor of contaminated exhaust emission. It is a critical issue not to detect this abnormality. The following method may be considered as an improved method of the diagnosis system.

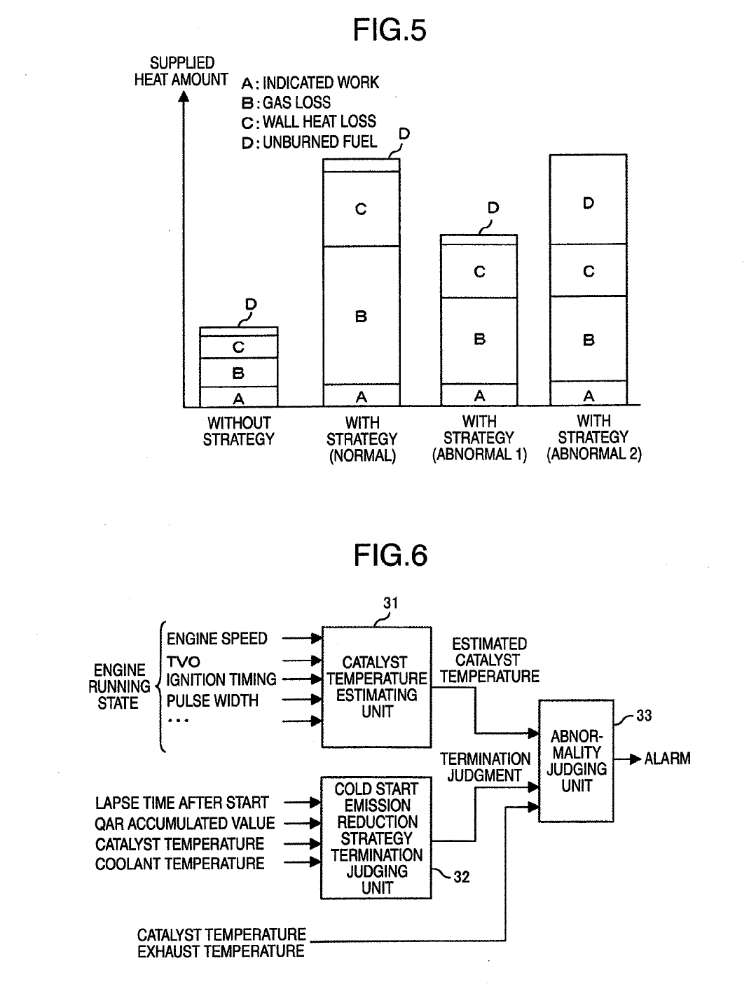

FIG. 6 illustrates an example of the improved method of the diagnosis system. In addition to the catalyst temperature estimating unit 31 and cold start emission reduction strategy termination judging unit 32 illustrated in FIG. 4, a temperature sensor is provided to measure a catalyst temperature and an exhaust emission temperature and detect the second abnormality illustrated in FIG. 5. However, since the temperature sensor is necessary, the cost increases and it is necessary to diagnose the temperature sensor itself.

This embodiment pays attention to a wall heat loss which increases during execution of cold start emission reduction strategy as illustrated in FIG. 5, and discloses diagnosis technique utilizing an already existing coolant temperature sensor.

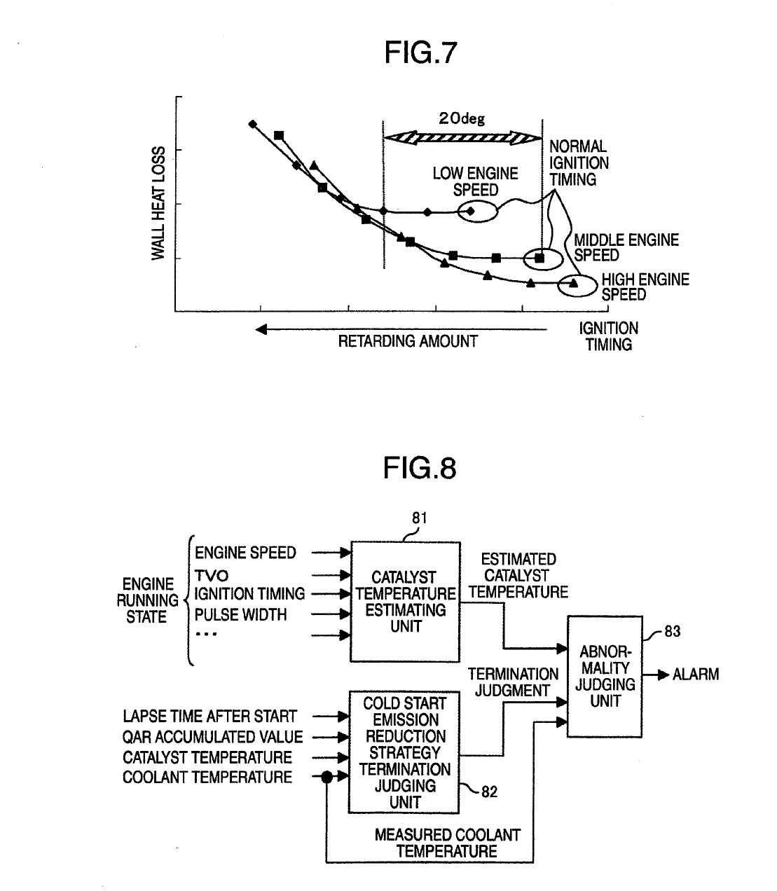

FIG. 7 is a diagram illustrating a relation between retarding of an ignition timing and a wall heat loss. The cold start emission reduction strategy retards an ignition timing by 20 deg or more from a normal ignition timing. Retarding of an ignition timing makes a wall heat loss two times or more than that for the normal ignition timing, although it depends on an engine speed. This means that a coolant temperature rises at a double speed during execution of cold start emission reduction strategy. It is obvious that there are factors other than retarding of the ignition timing, which factors contribute to the coolant temperature rise. In the following, disclosure will be made on the diagnosis technique utilizing an estimated coolant temperature and a measured coolant temperature.

### First Embodiment

FIG. 8 is a diagnosis block diagram illustrating the outline of the first embodiment. The embodiment provides a coolant temperature estimating unit 81 for estimating a cooling coolant temperature from an internal combustion engine running state such as an engine speed, and a cold start emission reduction strategy termination judging unit 82 for judging a termination of cold start emission reduction strategy from a lapse time from a start or the like. An abnormality judging unit 83 judges abnormality of the cold start emission reduction strategy, in accordance with an estimated coolant temperature at the time of termination judgment of the cold start emission reduction strategy and a measured coolant temperature detected with the coolant temperature sensor. Since abnormality is detected not only by the measured coolant temperature but also by the estimated coolant temperature, abnormality can be detected reliably even if a change speed of a coolant temperature changes with an internal combustion engine running state or the like.

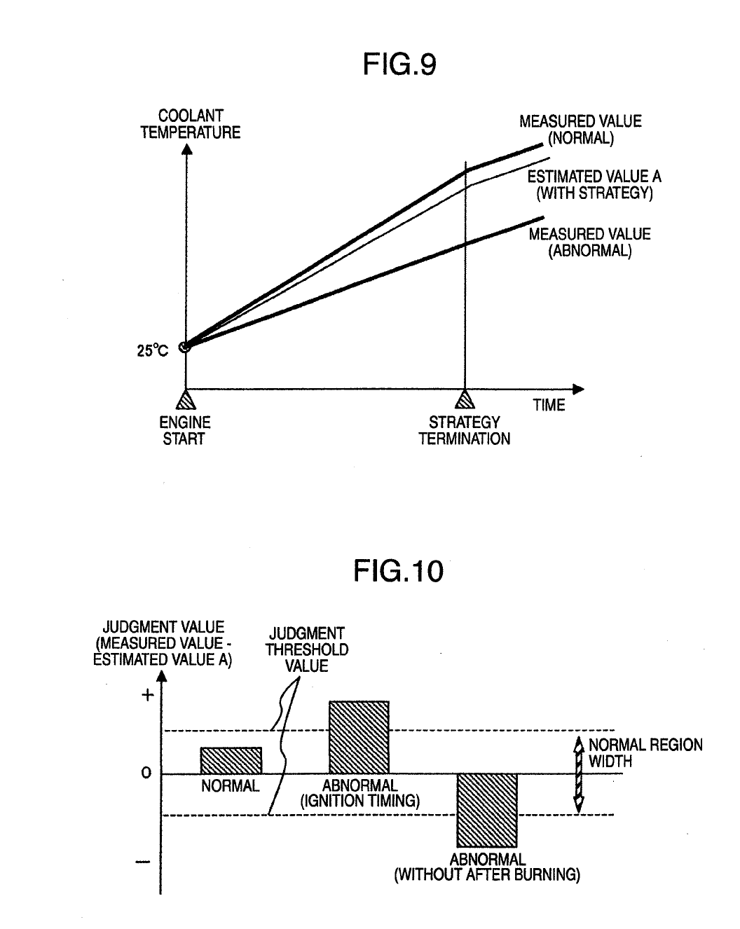

FIG. 9 illustrates an example of the timing chart of the embodiment. A coolant temperature under execution (control) of cold start emission reduction strategy is estimated from an internal combustion engine running state by a method to be described later, by using a cooling coolant temperature at the start time of the internal combustion engine. The other measured coolant temperature (measured value) is near at the estimated coolant temperature (estimated value A) if the cold start emission reduction strategy is normal, whereas if abnormal, the measured value is much separated from the value near at the estimated value. Abnormality can be judged from a difference between the estimated value A and measured value, an accumulated value of differences, or a difference between temperature rise speeds of the estimated value and measured value. Description will be made on a simplest abnormality judging method for the cold start emission reduction strategy by using a difference between a measured value and estimated value A at the time of termination of the cold start emission reduction strategy.

FIG. 10 illustrates an example of abnormality judgment. In this example, it is judged normal if a difference (judgment value A) between the measured value and estimated value of a coolant temperature at the termination time of the strategy is in a predetermined range, whereas it is judged abnormal if the difference is out of the predetermined range. In this case, abnormal states can be judged separately because the difference is positive in the abnormality that an ignition timing cannot be retarded or an engine speed cannot be increased, and negative in the abnormality that there is no after burning.

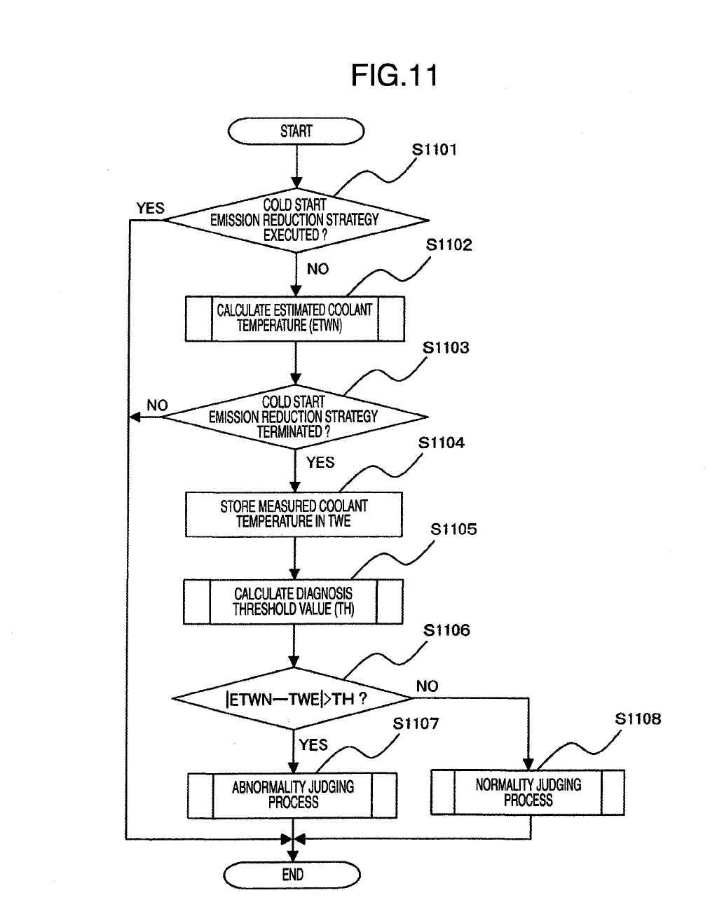

FIG. 11 illustrates an example of a flow chart of the embodiment. It is judged at Step S1101 whether the cold start emission reduction strategy is executed. If not, Step S1102 and following Steps are executed. At Step S1102, an estimated coolant temperature (ETWN) is calculated by a method to be described later to thereafter advance to Step S1103. It is judged at Step S1103 whether the cold start emission reduction strategy has been terminated, and if terminated, Step S1104 and following Steps are executed. At Step S1104, a temperature measured with the coolant temperature sensor is stored in TWE. At Step S1105 a diagnosis threshold value (TH) is calculated by a method to be described later. At Step S1106 an absolute value of a difference between the estimated coolant temperature (ETWN) and measured coolant temperature (TWE) is compared with the diagnosis threshold value. If it is judged at Step S1106 that the absolute value is larger than the threshold value, the flow advances to Step S1107, whereas if smaller, the flow advances to Step S1108. Step S1107 is an abnormality judging process at which an abnormality code is stored in a memory, and an alarm lamp is turned on. Step S1108 is a normality judging process at which an indication that the cold start emission reduction strategy was executed is stored in the memory. This flow chart is executed by the control unit of the internal combustion engine, for example, every 10 ms.

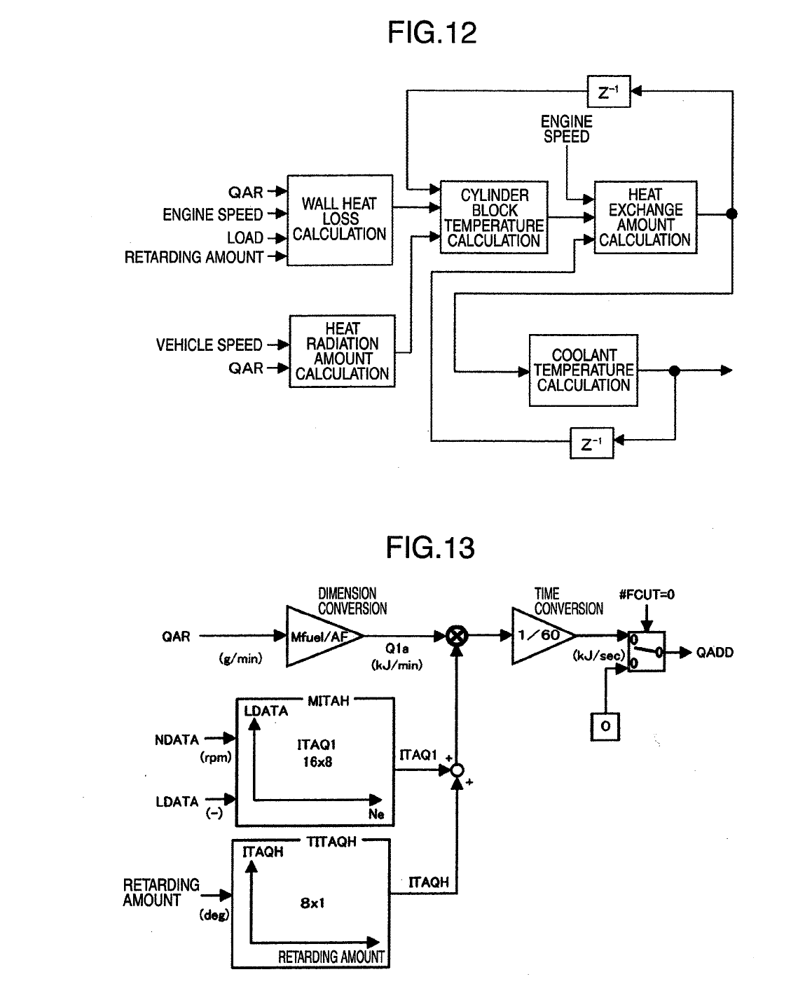

FIG. 12 illustrates the outline of an estimated coolant temperature calculating method. In this example, a cooling coolant temperature is calculated from a heat balance of a cylinder block. A wall heat loss in the cylinder block is calculated from an intake air amount (QAR), an engine speed, an engine load, an ignition timing retarding amount and the like by a method to be described later. The heat radiation amount due to a running wind and fuel cut is calculated from a vehicle running speed and an intake air amount by a method to be described later. The cylinder block temperature is calculated in accordance with a heat exchange amount of coolant as well as the above-described supplied heat amount and heat radiation amount. A heat radiation amount is proportional to a difference between a coolant temperature and a cylinder block temperature, and is calculated by using a coefficient corresponding to a flow rate of coolant. The estimated coolant temperature can be calculated by accumulating the above-described heat exchange amount, and using as an initial value a coolant temperature at the start time. According to this method, since a coolant temperature can be estimated even during running, abnormality of cold start emission reduction strategy can be detected correctly even if the vehicle is running during execution or termination of the cold start emission reduction strategy.

The details of the coolant temperature estimating method will be described in detail with reference to FIGS. 13 to 20.

FIG. 13 is a block diagram illustrating calculation of a heating value of the wall heat loss Qadd transmitted to the cylinder block. A supplied heat amount Q1a is calculated from an intake air amount QAR, by using an air/fuel ratio AF and a gasoline lower heating value Mfuel. The supplied heat amount is multiplied by a wall heat loss ITAQ1 determined by an engine speed and load and by a wall heat loss correction amount ITAQH determined by a retarding amount, to calculate the wall heat loss Qadd. During execution of fuel cut CUT=1, Qadd is set to 0. With this arrangement, a temperature of coolant can be calculated correctly in any states of various engine loads, ignition timings and fuel cut. In this block diagram, although the supplied heat amount Q1a is calculated from the intake air amount, the supplied heat amount may be calculated from a fuel injection pulse width. Instead of setting Qadd to 0, a heat amount generated by mechanical friction loss may be added.

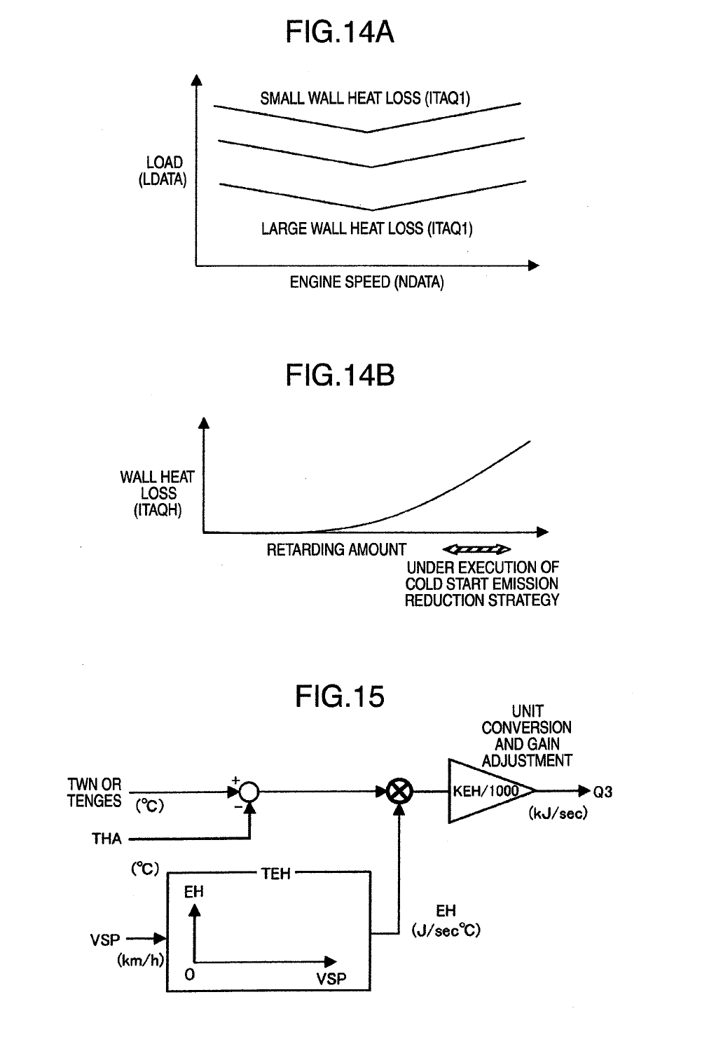

FIGS. 14A and 14B illustrate examples of a wall heat loss MAP. FIG. 14A illustrates MAP for calculating a proportion of the wall heat loss to the supplied heat amount Q1a based on an engine speed and load. Generally, the smaller the load is, the larger the wall heat loss is. The wall heat loss becomes larger if an engine speed is slower or conversely if an engine speed is higher. FIG. 14B illustrates MAP indicting an increment of a wall heat loss relative to a retarding amount of an ignition timing. These MAP's are obtained by calculating a wall heat loss from the results of an internal combustion engine steady test. As illustrated in FIG. 14B, the embodiment is applicable in a case that the wall heat loss increases during execution of cold start emission reduction strategy.

FIG. 15 is a block diagram illustrating calculation of a dissipated heat Q3 from the surface of a cylinder block to an ambient air. The heat amount Q3 dissipated to the ambient air is calculated from a product of a difference between an estimated cylinder block temperature (TENGES) and the ambient air temperature (THA) and a heat radiation coefficient EH determined by a vehicle speed. This calculates a heat radiation amount of the cylinder block deprived by a running wind, and a coolant temperature while the vehicle is running can be estimated more correctly.

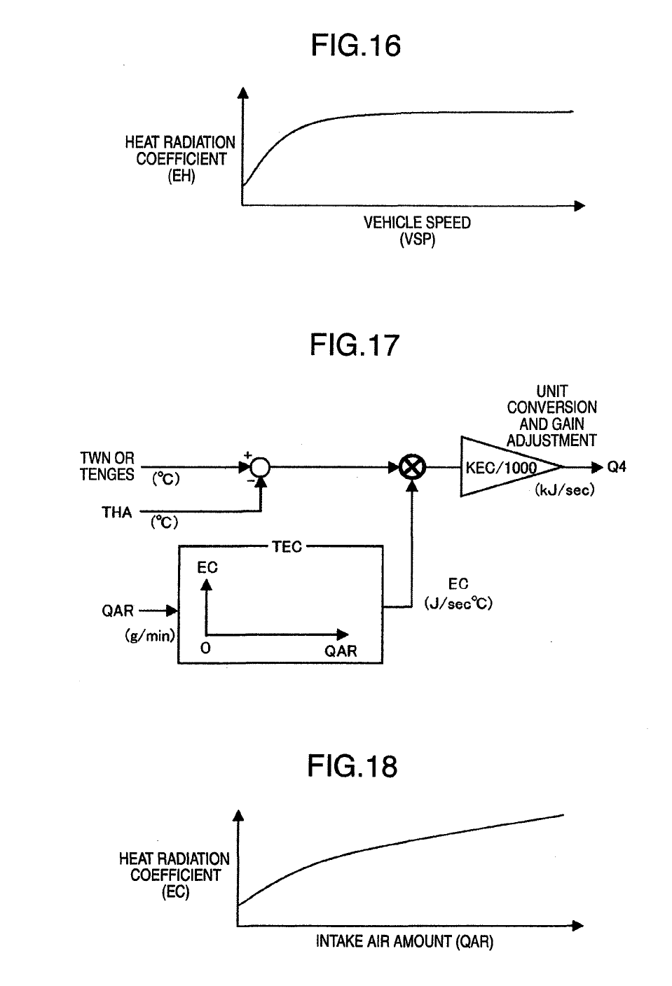

FIG. 16 illustrates an example of a table of a heat radiation coefficient EH. As illustrated in FIG. 16, the higher a vehicle speed is, a running wind deprives more heat from the cylinder block. Therefore, a heat radiation coefficient EH becomes large as the vehicle speed becomes high. In accordance with similar concept, a heat radiation amount of a radiator and a heater may be calculated to be added to the heat radiation amount of the cylinder block.

FIG. 17 is a block diagram illustrating calculation of a dissipated heat Q4 during fuel cut. The heat amount Q4 dissipated to the combustion chamber is calculated from a product of a difference between an estimated cylinder block temperature (TENGES) and an ambient air temperature (THA) and a heat radiation coefficient EC determined by an air flow rate QAR during fuel cut. This calculates a heating value dissipated by cooling the cylinder block by an air flowing into the internal combustion engine, and a coolant temperature particularly during fuel cut can be estimated correctly. In FIGS. 15 and 17, although the heat radiation coefficient is calculated from a difference between an estimated cylinder block temperature (TENGES) and an ambient air temperature, a measured coolant temperature (TWN) may be used instead of the estimated cylinder block temperature.

FIG. 18 illustrates an example of a table of a heat radiation coefficient EC. The larger the intake air amount QAR is, the heat radiation coefficient EC becomes larger. This is because the larger the intake air amount is, the air deprives more heat. Next, description will be made on a method of calculating a cylinder block temperature (TENGES) and a coolant temperature (TWNES) in accordance with the above-described wall heat loss Qadd and the heat radiation amount QDEC which is a sum of the radiated heats Q3 and Q4.

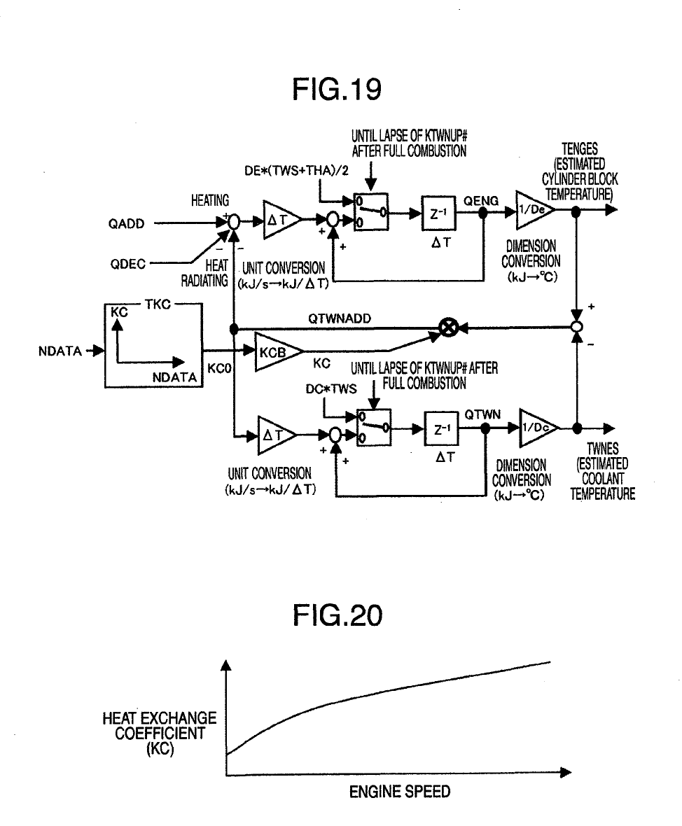

FIG. 19 is a block diagram illustrating estimation of a coolant temperature TWNES and a cylinder block temperature TENGES. The above-described wall heat loss QADD and a heat radiation QDEC are accumulated at a program execution interval (about 1000 to 10 ms), and an estimated cylinder block temperature (estimated coolant temperature) TENGES is calculated from a heat amount QENG and a heat capacity DE of the cylinder block. A heat exchange amount QTWNADD of the coolant and cylinder block is calculated in accordance with a difference between the estimated cylinder block temperature TWNES and an estimated coolant temperature TWENS calculated in a similar manner, and the heat radiation coefficient KC. This calculated heat exchange amount is accumulated at every sampling time ΔT, and an estimated coolant temperature TWNES is calculated from the coolant heat amount QTWN and heat capacity DC. A coolant temperature can be estimated more correctly by utilizing heat balance of the cylinder block.

FIG. 20 illustrates a relation between a heat exchange coefficient KC and an engine speed NDATA. The heat exchange coefficient KC becomes large as a flow rate of coolant becomes large. However, since there is generally no device for detecting a flow rate of coolant, the relation between the engine speed and heat exchange coefficient is illustrated by incorporating a proportional relation between a flow rate of coolant and an engine speed. In this manner, a correct coolant temperature can be estimated even if there is no flow rate sensor.

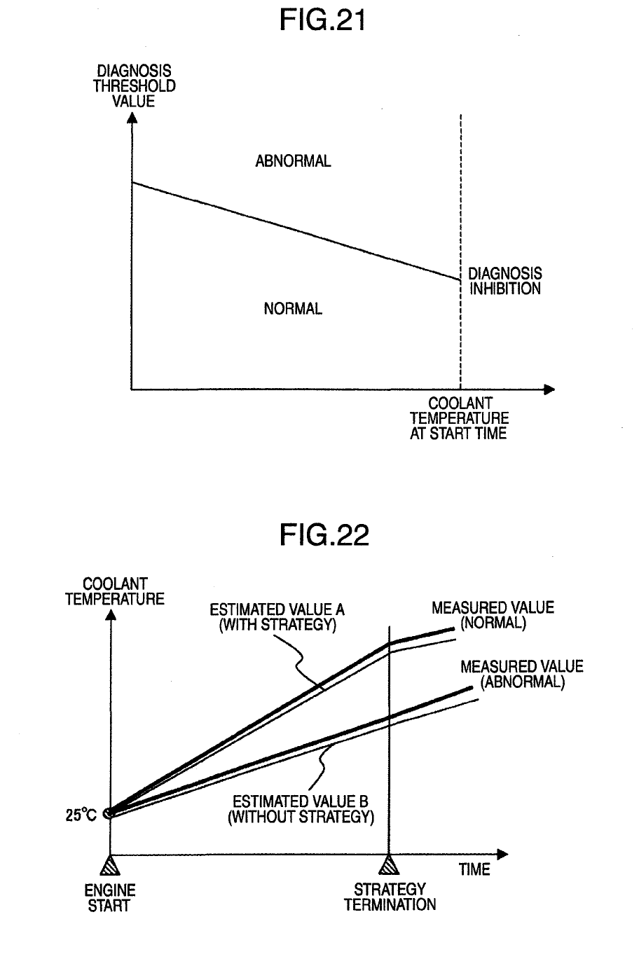

FIG. 21 illustrates an example of a diagnosis threshold value based upon a coolant temperature at the start time. The higher the coolant temperature at the start time is, a rise width of a coolant temperature becomes narrower. As a result, a difference between the estimated value and measured value of coolant temperature becomes smaller. A diagnosis threshold value is therefore set smaller the higher the coolant temperature at the start time is. As the coolant temperature at the start time takes a predetermined value or higher, an execution time of cold start emission reduction strategy becomes short and a difference between the estimated and measured values exist hardly. Diagnosis is therefore prohibited. By setting the threshold value in accordance with a coolant temperature at the start time, abnormality can be judged more reliably.

### Second Embodiment

Next, description will be made on a method of calculating an estimated temperature if there is no effect of cold start emission reduction strategy even under execution of the cold start emission reduction strategy, and improving a judgment precision of abnormality judgment.

FIG. 22 is a timing chart illustrating abnormality judgment using an estimated coolant temperature (estimated value A) with cold start emission reduction strategy and an estimated coolant temperature (estimated value B) without cold start emission reduction strategy. The estimated value B is calculated by subtracting an intake air increment amount, an engine speed increment amount and a retarding amount of the cold start emission reduction strategy, from internal combustion engine parameters. A difference between two estimated values represents a coolant temperature rise amount due to the cold start emission reduction strategy. Therefore, if a difference is small even if the cold start emission reduction strategy is executed, it is possible to judge abnormal. Abnormality may also be judged in accordance with a criterion whether a measured coolant temperature at the strategy termination is near to which value of the estimated values A and B.

Description will be made in the following on a method of determining a threshold value in accordance with the estimated values A and B, by using as a diagnosis index an absolute value of a difference between the estimated coolant temperature A and a measured coolant temperature.

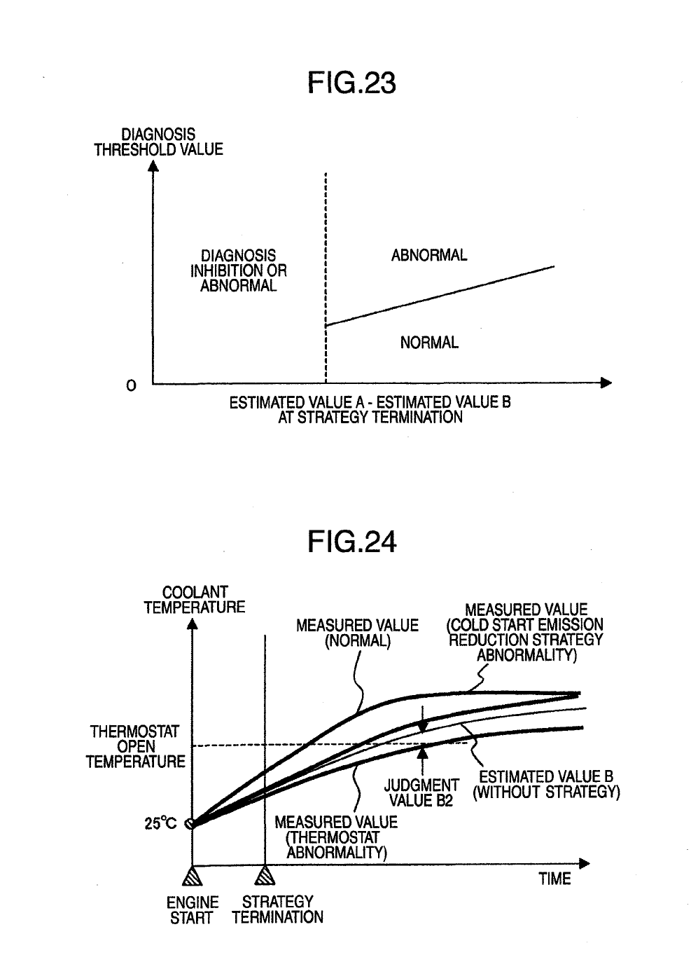

FIG. 23 illustrates an example of a diagnosis threshold value using two estimated values. A diagnosis threshold value is determined from a difference of the estimated value B from the estimated value A. The larger this difference is, the higher the temperature rise during cold start emission reduction strategy is. Therefore, by setting the threshold value large, erroneous diagnosis is prevented. If this difference is smaller than a predetermined value, a temperature rise during cold start emission reduction strategy is small. In this case, either abnormality is judged or diagnosis is inhibited, by considering a ratio of cold start emission reduction strategy covering a vehicle exhaust emission performance. In this example, diagnosis can be performed more reliably than using the coolant temperature as the start time.

### Third Embodiment

A method is disclosed which separates thermostat abnormality and cold start emission reduction strategy abnormality.

FIG. 24 is a timing chart illustrating a coolant temperature during abnormality of a thermostat of an engine cooling system. In this example, coolant is cooled by a radiator because of open failure of a thermostat, and a coolant temperature is lower than the estimated value B. Since the estimated value B is an estimated value without execution of cold start emission reduction strategy, if the measured value is lower than the estimated value B at the strategy termination, thermostat abnormality is judged.

In order to judge thermostat abnormality more reliably, a difference (judgment value B2) between the estimated value B and measured value at a thermostat open temperature is used. A lowered coolant temperature due to thermostat abnormality becomes large as a difference between the coolant temperature and an ambient air temperature becomes large. Since a difference between the estimated value and measured value B at a thermostat open temperature becomes larger than that at the strategy termination time, this is utilized to enable more reliable judgment.

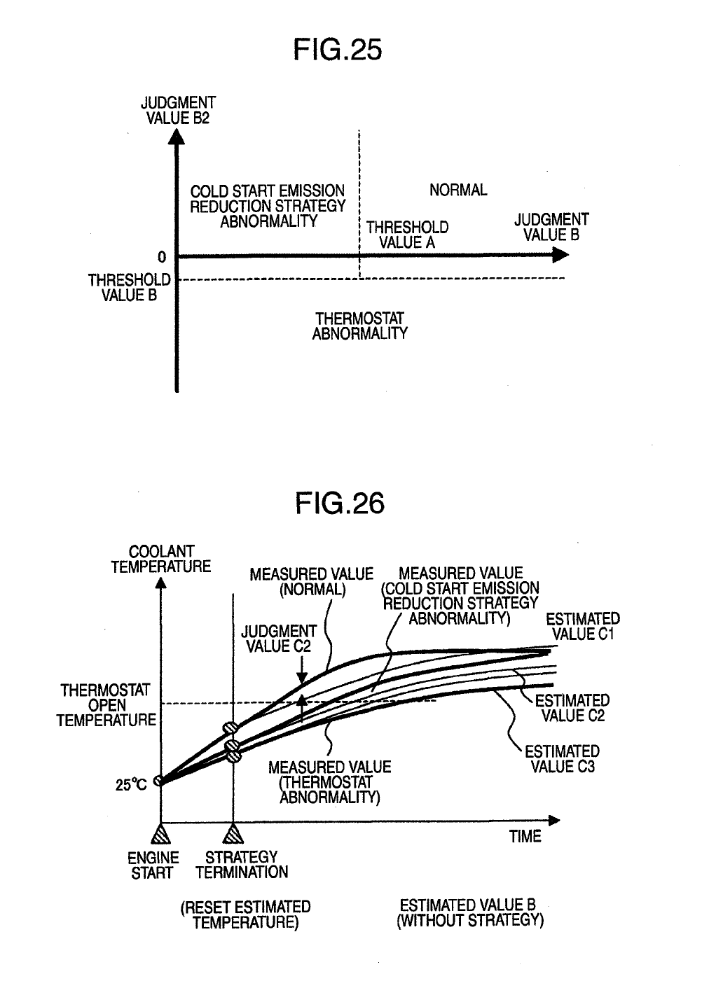

FIG. 25 illustrates an example of an abnormality discrimination method for the thermostat and cold start emission reduction strategy. A judgment value B is a difference between an estimated value B and a measured value at the strategy termination time, and a judgment value B2 is a difference between the estimated value B and measured value when the measured value reaches a thermostat open temperature (about 80° C.). According to this method, if the judgment value B is smaller than the threshold value A, it is judged that the cold start emission reduction strategy is abnormal or the thermostat is abnormal, because the coolant temperature rise is lower than that in the normal state. In this case, if the estimated value B2 is smaller than the threshold value B, it is regarded that the coolant temperature is lowered by radiator cooling, and it is judged that the thermostat is abnormal, whereas not smaller, it is judged that the cold start emission reduction strategy is abnormal. It is also possible to judge that the thermostat is abnormal, if the judgment value B2 does not exceed the threshold value B2, irrespective of the judgment value B.

FIG. 26 illustrates another example of discrimination of thermostat abnormality. In this example, an estimated value is reset by using a measured value at the termination time of cold start emission reduction strategy. In this embodiment, a coolant heat amount is calculated from a measured value. In this case, a difference (judgment value C) between a measured value and estimated value C when the measured value reaches a thermostat open temperature, is not influenced by the cold start emission reduction strategy. It is therefore possible to discriminate thermostat abnormality more precisely.

Abnormality discrimination between the thermostat and cold start emission reduction strategy is possible by the above-described method, even if an estimated coolant temperature considering heat radiation by a radiator during a thermostat open failure is used. In this example, although a thermostat open temperature is used as a temperature for separating thermostat abnormality, a time after a predetermined time from when an electrically activated water pump starts operating may be used, if the internal combustion engine is equipped with the electrically activated water pump.

According to the embodiments described above, by comparing a coolant temperature measured with a coolant temperature sensor with a coolant temperature estimated from an internal combustion engine running state, it becomes possible to detect exhaust emission degradation to be caused by a reduced after-burning amount due to secular change or the like.

It should be further understood by those skilled in the art that although the foregoing description has been made on embodiments of the invention, the invention is not limited thereto and various changes and modifications may be made without departing from the spirit of the invention and the scope of the appended claims.

1. A diagnosis apparatus for an internal combustion engine equipped with cold start emission reduction strategy means, comprising:
temperature measuring means for detecting a temperature of coolant of said internal combustion engine;
temperature estimating means for calculating an estimated temperature of said coolant in accordance with a running state of said internal combustion engine; and
cold start emission reduction strategy abnormality judging means for judging abnormality of said cold start emission reduction strategy means in accordance with the temperature detected with said temperature measuring means and said estimated temperature.

2. The diagnosis apparatus for an internal combustion engine according to claim 1, wherein
at least one of an amount of ignition timing retarding, an increased amount of intake air and an increased amount of an idle speed by said cold state emission reduction strategy means is used as the running state of said internal combustion engine.

3. The diagnosis apparatus for an internal combustion engine according to claim 1, wherein
said temperature estimating means obtains a heat exchange amount which is a portion of cooling heat calculated from the running state of said internal combustion engine in accordance with a difference between a temperature of a cylinder block of said internal combustion engine and a temperature of said coolant, and estimates a temperature of said coolant from said heat exchange amount.

4. The diagnosis apparatus for an internal combustion engine according to claim 3, wherein
said cold start emission reduction strategy means is judged abnormal if a difference between said measured temperature and said estimated temperature is larger than a first predetermined value determined from a coolant temperature at the start time.

5. The diagnosis apparatus for an internal combustion engine according to claim 3, wherein
an estimated temperature A of said coolant when said cold start emission reduction strategy means is not used is calculated, an estimated temperature B of said coolant when said cold start emission reduction strategy means is used is calculated, and abnormality of said cold start emission reduction strategy means is judged in accordance with at least two of said estimated temperature A, said estimated temperature B, and said measured temperature.

6. The diagnosis apparatus for an internal combustion engine according to claim 5, wherein
said cold start emission reduction strategy means is judged abnormal if a difference between said estimated temperature A and said estimated temperature B when control by said cold state emission reduction strategy means is completed is smaller than a second predetermined value determined from a coolant temperature at the start time.

7. The diagnosis apparatus for an internal combustion engine according to claim 5, wherein
abnormality of said cold start emission reduction strategy means is judged through comparison between at least one of a difference between said estimated temperature A and said measured temperature and a difference between said estimated temperature B and said measured temperature, and a third predetermined value determined from a difference between said estimated temperature A and said estimated temperature B.

8. The diagnosis apparatus for an internal combustion engine according to claim 1, wherein
abnormality of said cold state emission reduction strategy means and a thermostat for switching between flow paths of said coolant in accordance with a temperature is judged separately in accordance with a first judgment value based on said estimated temperature and said measured temperature when control by said cold start emission reduction strategy means is completed, and a second judgment value based on said estimated temperature and said measured temperature near at a temperature for between the flow paths by the thermostat.

9. The diagnosis apparatus for an internal combustion engine according to claim 5, wherein
a thermostat for switching between flow paths of said coolant in accordance with a temperature is judged abnormal if said measured temperature is lower than said estimated temperature when control by said cold start emission reduction strategy means is completed.

10. A diagnosis apparatus for an internal combustion engine equipped with cold start emission reduction strategy means, comprising:
temperature estimating means for calculating an estimated temperature of said internal combustion engine in accordance with a running state of said internal combustion engine; and
abnormality judging means for judging presence/absence of abnormality of said cold start emission reduction strategy means in accordance with an externally input and actually measured temperature of said coolant and said estimated temperature.
